(19) United States
(12) Patent Application Publication
(10) Pub. No.: US 2011/0052920 A1
(43) Pub. Date: Mar. 3, 2011

(54) POLYESTER AND POLYTRIMETHYLENE ETHER DIOL BASED COATING COMPOSITION

(75) Inventors: Ayumu Yokoyama, Wallingford, PA (US); Sheau-Hwa Ma, West Chester, PA (US); Patricia Mary Ellen Sormani, Newark, DE (US)

(73) Assignee: E.I. DU PONT DE NEMOURS AND COMPANY, WILMINGTON (DE)

(21) Appl. No.: 12/989,802

(22) PCT Filed: Jun. 18, 2009
(86) PCT No.: PCT/US09/47782

§ 371 Date: Oct. 27, 2010

(30) Foreign Application Priority Data
Jun. 18, 2008 (US) 61073490

(51) Int. Cl. B32B 27/32; B05D 3/02; C08L 67/02; C08L 67/00

(52) U.S. Cl. 428/414; 427/393.5; 524/604; 524/599

(57) ABSTRACT

The present disclosure is directed to a coating composition having excellent adhesion and flexibility. This invention is further directed to a coating composition comprising components derived from renewable resources.

### FIELD OF DISCLOSURE

The present disclosure is directed to a coating composition having excellent adhesion to substrates, especially to the substrates having at least one existing coating layer. This invention is further directed to a coating composition comprising components derived from renewable resources.

### BACKGROUND OF DISCLOSURE

A typical coating finish over a substrate comprises some or all of the following layers: (1) one or more primer layers that provide adhesion and basic protection, such as corrosion protection; (2) one or more colored layers, typically pigmented, that provide most of the protection, durability and color; and (3) one or more clearcoat layers that provide additional durability and improved appearance. A colored topcoat layer can be used in place of the colored layer and clearcoat layer. A suitable primer, primer surfacer or primer filler, collectively referred to as “primer” herein, can be applied over the substrate to form the primer layer.

Epoxy primer is one of the primers that are commonly used in the industry for direct-to-metal coating applications that apply coatings directly onto metal substrates, such as vehicle bodies or body parts, steel tanks, pipelines, or other industrial structures. The colored layers plus clearcoat layers, or a single colored topcoat layer are commonly used to provide additional durability and appearance for these direct-to-metal coating applications. Adhesion between the primer layer, especially the epoxy primer layer and the colored layer is a challenge in the industry.

### STATEMENT OF DISCLOSURE

This invention is directed to a coating composition comprising a film forming binder, said binder consists essentially of:
A) a polyester having one or more hydroxyl crosslinkable functional groups and having a glass transition temperature (Tg) in a range of from −75° C. to 5° C.;
B) a polytrimethylene ether diol having a Mn (number average molecular weight) a range of from 500 to 10,000; and
C) a crosslinking component consisting essentially of at least one crosslinking agent having one or more crosslinking functional groups.

This invention is also directed to a process for coating a substrate having at least one existing coating layer thereon, said process comprising the steps of:
(A) applying a coating composition over said existing coating layer to form an overlay coating layer, wherein said coating composition comprises a film forming binder consisting essentially of:
   (i) a polyester having one or more hydroxyl crosslinkable functional groups and having a glass transition temperature (Tg) in a range of from −75° C. to 5° C.;
   (ii) a polytrimethylene ether diol having a Mn (number average molecular weight) a range of from 500 to 10,000; and
   (iii) a crosslinking component consisting essentially of at least one crosslinking agent having one or more crosslinking functional groups.
(B) curing said overlay coating layer to form an overlay coating on said substrate.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about.” In this manner, slight variations above and below the stated ranges can be used to achieve substantially the same results as values within the ranges. Also, the disclosure of these ranges is intended as a continuous range including every value between the minimum and maximum values.

As used herein:

The term “(meth)acrylate” means methacrylate or acrylate.

The term “two-pack coating composition”, also known as 2K coating composition, refers to a coating composition having two packages that are stored in separate containers and sealed to increase the shelf life of the coating composition during storage. The two packages are mixed just prior to use to form a pot mix, which has a limited pot life, typically ranging from a few minutes (15 minutes to 45 minutes) to a few hours (4 hours to 8 hours). The pot mix is then applied as a layer of a desired thickness on a substrate surface, such as an automobile body. After application, the layer dries and cures at ambient or at elevated temperatures to form a coating on the substrate surface having desired coating properties, such as, high gloss, mar-resistance and resistance to environmental etching.

The term “crosslinkable component” refers to a component having “crosslinkable functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with crosslinking functional groups (during the curing step) to produce a coating in the form of crosslinked structures. One of ordinary skill in the art would recognize that certain crosslinkable functional group combinations would be excluded, since, if present, these combinations would crosslink among themselves (self-crosslink), thereby destroying their ability to crosslink with the crosslinking functional groups. A workable combination of crosslinkable functional groups refers to the combinations of crosslinkable functional groups that can be used in coating applications excluding those combinations that would self-crosslink.

Typical crosslinkable functional groups can include hydroxyl, thiol, isocyanate, thioisocyanate, acetoacetoxy, carboxyl, primary amine, secondary amine, epoxy, anhydride, ketimine, aldimine, or a workable combination thereof. Some other functional groups such as orthoester, orthocarbonate, or cyclic amide that can generate hydroxyl or amine groups once the ring structure is opened can also be suitable as crosslinkable functional groups.

The term “crosslinking component” refers to a component having “crosslinking functional groups” that are functional groups positioned in each molecule of the compounds, oligomer, polymer, the backbone of the polymer, pendant from the backbone of the polymer, terminally positioned on the backbone of the polymer, or a combination thereof, wherein these functional groups are capable of crosslinking with the crosslinkable functional groups (during the curing step) to produce a coating in the form of crosslinked structures. One of ordinary skill in the art would recognize that certain crosslinking functional group combinations would be excluded, since, if present, these combinations would crosslink among themselves (self-crosslink), thereby destroying their ability to crosslink with the crosslinkable functional groups. A workable combination of crosslinking functional groups refers to the combinations of crosslinking functional groups that can be used in coating applications excluding those combinations that would self-crosslink. One of ordinary skill in the art would recognize that certain combinations of crosslinking functional group and crosslinkable functional groups would be excluded, since they would fail to crosslink and produce the film forming crosslinked structures. The crosslinking component can comprise one or more crosslinking agents that have the crosslinking functional groups.

Typical crosslinking functional groups can include hydroxyl, thiol, isocyanate, thioisocyanate, acetoacetoxy, carboxyl, primary amine, secondary amine, epoxy, anhydride, ketimine, aldimine, orthoester, orthocarbonate, cyclic amide or a workable combination thereof.

It would be clear to one of ordinary skill in the art that certain crosslinking functional groups crosslink with certain crosslinkable functional groups. Examples of paired combinations of crosslinkable and crosslinking functional groups can include: (1) amine and protected amine such as ketimine and aldimine functional groups generally crosslink with acetoacetoxy, epoxy, or anhydride functional groups; (2) isocyanate, thioisocyanate and melamine functional groups generally crosslink with hydroxyl, thiol, primary and secondary amine, ketimine, or aldimine functional groups; (3) epoxy functional groups generally crosslink with carboxyl, primary and secondary amine, ketimine, aldimine or anhydride functional groups; and (4) carboxyl functional groups generally crosslink with epoxy or isocyanate functional groups.

The term “binder” as used herein refers to film forming constituents of a coating composition. Typically, a binder can comprise a crosslinkable component and a crosslinking component in that the crosslinkable component can react with the crosslinking component to form crosslinked structures, such as coating films. The binder in this invention can further comprise other polymers that are essential for forming the crosslinked films having desired properties. Additional components, such as solvents, pigments, catalysts, rheology modifiers, antioxidants, UV stabilizers and absorbers, leveling agents, antifoaming agents, anti-cratering agents, or other conventional additives are not included in the term. One or more of those additional components can be included in the coating composition.

A substrate suitable for this invention can be a plastic, bare metal such as blasted steel, aluminum or other metal or alloys. One example of the blasted steel can be the one available from East Coast Steel Inc, Columbia, S.C. 29290, USA. The substrate can also be plastic or metal substrates with one or more existing coating layers. One example can be a steel substrate coated with an eletrocoat (e-coat) layer. Another example can be a steel substrate coated with an eletrocoat (e-coat) layer and a primer layer. Yet another example can be a steel substrate coated with a primer layer. Yet another example can be a steel substrate coated with a primer layer and a colored coating layer. The primer layer can be produced with an epoxy primer, an acrylic primer, a polyester primer, or other primers known to those skilled in the art. An epoxy primer means a primer composition comprises at least one epoxy resin or its derivatives. An acrylic primer means a primer composition comprises at least one acrylic resin or its derivatives. A polyester primer means a primer composition comprises polyesters or polyester derivatives.

The coating composition of this invention comprises a film forming binder, herein referred to as the binder. Said binder can comprise:
A) a polyester having one or more crosslinkable functional groups and having a glass transition temperature (Tg) in a range of from −75° C. to +5° C.;
B) a polytrimethylene ether diol having a Mn (number average molecular weight) in a range of from 500 to 10,000; and
C) a crosslinking component comprising at least one crosslinking agent having one or more crosslinking functional groups.

In one example, the binder of the coating composition of this invention, besides solvents, can consist essentially of:
A) a polyester having one or more crosslinkable functional groups and having a glass transition temperature (Tg) in a range of from −75° C. to 5° C.;
B) a polytrimethylene ether diol having a Mn (number average molecular weight) in a range of from 500 to 10,000; and
C) a crosslinking component consisting essentially of at least one crosslinking agent having one or more crosslinking functional groups.

The binder can contain: (a) in a range of from 20% to 80% by weight in one example, 20% to 70% by weight in another example, of the polyester; (b) in a range of from 1% to 50% by weight in one example, 1% to 30% by weight in another example, of the polytrimethylene ether diol and (c) in a range of from 10% to 50% by weight in one example and 10% to 45% by weight in another example of the crosslinking agent. All weight percentages are based on the total weight of the binder composition. In one embodiment, the coating composition of this invention has a molar ratio of NCO:OH in a range of from 0.8:1.0 to 1.5:1.0. In another embodiment, the molar ratio of NCO:OH can be in a range of from 0.9:1.0 to 1.1:1.0

The polyester suitable for the coating composition of this invention can be hydroxyl containing polyesters having hydroxyl crosslinkable functional groups. Typical polyesters that can be used for this invention can have an acid value of 15 to 60 and have a weight average molecular weight (Mw) from 1,000 to 50,000. The polyesters may be saturated or unsaturated and optionally, chemically modified. These polyesters are the esterification product of one or more polyhydric alcohols, such as, alkylene diols and glycols; and acids, such as monocarboxylic acids and polycarboxylic acids or anhydrides thereof, such as, dicarboxylic and/or tricarboxylic acids or tricarboxylic acid anhydrides. The polyester can be a linear polyester or a branched polyester.

The polyesters that are suitable for this invention can have a Tg (glass transition temperature) in a range of from −75° C. to 50° C., with one example in the range of from −75° C. to 40° C., another example in the range of from −75° C. to 30° C., yet another example in the range of from −75° C. to 10° C., yet another example in the range of from −75° C. to 5° C.

Examples of polyhydric alcohols that can be used to form the polyester can include triols and tetraols, such as, trimethylol propane, triethylol propane, trimethylol ethane, glycerine, and dihydric alcohols and diols that include ethylene glycol, propylene glycol, 1,3-propanediol, 1,3-butanediol, 1,4-butanediol, 1,5-pentanediol, 1,6-hexanediol, 2,2-dimethyl-1,3-propanediol, diethylene glycol, dipropylene glycol, 1,4-cyclohexane dimethanol, hydrogenated bisphenols A and F, Esterdiol 204 (Trademark of Union Carbide) and highly functional polyols, such as, trimethylolethane, trimethylolpropane, and pentaerythritol. Polyhydric alcohols having carboxyl groups may be used, such as, dimethylol propionic acid (DMPA).

Typical acids and anhydrides that can be used to form the polyester can include aliphatic or aromatic carboxylic acids and anhydrides thereof, such as, adipic acid, azelaic acid, sebacic acid, dimerized fatty acids, maleic acid, maleic anhydride, succinic acid, succinic anhydride, isophthalic acid, terephthalic acid, phthalic acid, phthalic anhydride, dimethyl terephthalic acid, naphthalene dicarboxylic acid, tetrahydro- and hexahydrophthalic anhydride, tetrachlorophthalic acid, terephthalic acid bisglycol ester, benzophenone dicarboxylic acid, trimellitic acid and trimellitic anhydride.

One example of a polyester suitable for this invention can be the esterification product of neopentyl glycol, trimethylol propane, 1,6 hexane diol, adipic acid, isophthalic acid and trimellitic anhydride.

The polyester can be a highly branched copolyester. The highly branched copolyester can have a weight average molecular weight in a range of from 1,000 to 50,000, with one example in the range of 1,000-40,000, another example in the range of 1,500-40,000, yet another example in the range of 1,500 to 30,000, and yet another example in the range of 2,000 to 30,000. The highly branched copolyester can have one or more hydroxyl crosslinkable function groups.

The highly branched copolyester can be conventionally polymerized from a monomer mixture containing a chain extender selected from the group consisting of a hydroxy carboxylic acid, a lactone of a hydroxy carboxylic acid and a combination thereof; and one or more hyper branching monomers.

One example of a highly branched polyester suitable for this invention can be synthesized by reacting dimethylol propionic acid, pentaerythritol, and caprolactone.

Conventional methods for synthesizing polyesters are known to those skilled in the art. Examples of the conventional methods can include those described in U.S. Pat. No. 5,270,362 and U.S. Pat. No. 6,998,154.

The polytrimethylene ether diol suitable for the coating composition of this invention can have a number average molecular weight (Mn) in the range of from 150 to 10,000. The polytrimethylene ether diol can have a Tg of about −75° C. The polytrimethylene ether diol can have a polydispersity in the range of from 1.1 to 2.1 and a hydroxyl number in the range of from 20 to 200.

Suitable polytrimethylene ether diol can be prepared by an acid-catalyzed polycondensation of 1,3-propanediol, such as described in U.S. Pat. Nos. 6,977,291 and 6,720,459. The polytrimethylene ether diol can also be prepared by a ring opening polymerization of a cyclic ether, oxetane, such as described in J. Polymer Sci., Polymer Chemistry Ed. 28, 449 to 444 (1985). The polycondensation of 1,3-propanediol is preferred over the use of oxetane since the diol is a less hazardous, stable, low cost, commercially available material and can be prepared by use of petro chemical feed-stocks or renewable resources.

A bio-route via fermentation of a renewable resource can be used to obtain the 1,3-propanediol. One example of renewable resources is corn since it is readily available and has a high rate of conversion to 1,3-propanediol and can be genetically modified to improve yields to the 1,3-propanediol. Examples of typical bio-route can include those described in U.S. Pat. No. 5,686,276, U.S. Pat. No. 5,633,362 and U.S. Pat. No. 5,821,092.

Copolymers of polytrimethylene ether diol also can be suitable for the coating composition of this invention. Examples of such suitable copolymers of polytrimethylene ether diol can be prepared by copolymerizing 1,3-propanediol with another diol, such as, ethane diol, hexane diol, 2-methyl-1,3-propanediol, 2,2-dimethyl-1,3-propanediol, trimethylol propane and pentaerythritol. In one example, the copolymers of polytrimethylene ether diol can be polymerized from monomers have 1,3-propanediol in a range of from 50% to 99%. In another example, the copolymers of polytrimethylene ether diol can be polymerized from monomers have 1,3-propanediol in a range of from 60% to 99%. In yet another example, the copolymers of polytrimethylene ether diol can be polymerized from monomers have 1,3-propanediol in a range of from 70% to 99%.

A blend of a high and a low molecular weight polytrimethylene ether diol can be used. In one example, the high molecular weight polytrimethylene ether diol can have a number average molecular weight (Mn) in a range of from 1,000 to 4,000 and the low molecular weight polytrimethylene ether diol can have an Mn in a range of from 150 to 500, and the average Mn of the blended polytrimethylene ether diol can be in a range of from 500 to 4,000. In another example, the high molecular weight polytrimethylene ether diol can have an Mn in a range of from 1,000 to 4,000 and the low molecular weight polytrimethylene ether diol can have an Mn in a range of from 150 to 500 and the average Mn of the blend can be in a range of from 500 to 3,000.

Blends of the polytrimethylene ether diol and other cycloaliphatic hydroxyl containing either branched or linear oligomers can be used. Such hydroxyl containing oligomers are known to those skilled in the art. Examples of such hydroxyl containing oligomers can include those disclosed by Barsotti, et al. in U.S. Pat. No. 6,221,494.

The crosslinking agents that are suitable for the coating composition of this invention can include compounds having crosslinking functional groups. Examples of such compounds can include organic isocyanates and polyisocyanates. Examples of organic polyisocyanates can include aliphatic polyisocyanates, cycloaliphatic polyisocyanates, aromatic polyisocyanates and isocyanate adducts.

Examples of suitable aliphatic, cycloaliphatic and aromatic polyisocyanates that can be used include the following: 2,4-toluene diisocyanate, 2,6-toluene diisocyanate (“TDI”), 4,4-diphenylmethane diisocyanate (“MDI”), 4,4′-dicyclohexyl methane diisocyanate (“H12MDI”), 3,3′-dimethyl-4,4′-biphenyl diisocyanate (“TODI”), 1,4-benzene diisocyanate, trans-cyclohexane-1,4-diisocyanate, 1,5-naphthalene diisocyanate (“NDI”), 1,6-hexamethylene diisocyanate (“HDI”), 4,6-xylene diisocyanate, isophorone diisocyanate, (“IPDI”), other aliphatic or cycloaliphatic di-, tri- or tetra-isocyanates, such as, 1,2-propylene diisocyanate, tetramethylene diisocyanate, 2,3-butylene diisocyanate, octamethylene diisocyanate, 2,2,4-trimethyl hexamethylene diisocyanate, dodecamethylene diisocyanate, omega-dipropyl ether diisocyanate, 1,3-cyclopentane diisocyanate, 1,2-cyclohexane diisocyanate, 1,4-cyclohexane diisocyanate, 4-methyl-1,3-diisocyanatocyclohexane, dicyclohexylmethane-4,4′-diisocyanate, 3,3′-dimethyl-dicyclohexylmethane 4,4′-diisocyanate, polyisocyanates having isocyanurate structural units, such as, the isocyanurate of hexamethylene diisocyanate and the isocyanurate of isophorone diisocyanate, the adduct of 2 molecules of a diisocyanate, such as, hexamethylene diisocyanate, uretidiones of hexamethylene diisocyanate, uretidiones of isophorone diisocyanate and a diol, such as, ethylene glycol, the adduct of 3 molecules of hexamethylene diisocyanate and 1 molecule of water, allophanates, trimers and biurets, for example, of hexamethylene diisocyanate, allophanates, trimers and biurets, for example, of isophorone diisocyanate and the isocyanurate of hexane diisocyanate. MDI, HDI, TDI and isophorone diisocyanate are preferred because of their commercial availability.

Tri-functional isocyanates also can be used, such as, triphenyl methane triisocyanate, 1,3,5-benzene triisocyanate, 2,4,6-toluene triisocyanate. Trimers of diisocyanates, such as, the trimer of hexamethylene diisocyanate, sold as Tolonate® HDT from Rhodia Corporation and the trimer of isophorone diisocyanate are also suitable.

An isocyanate functional adduct can be used, such as, an adduct of an aliphatic polyisocyanate and a polyol or an adduct of an aliphatic polyisocyanate and an amine. Also, any of the aforementioned polyisocyanates can be used with a polyol to form an adduct. Polyols, such as, trimethylol alkanes, particularly, trimethylol propane or ethane can be used to form an adduct.

The coating composition of this invention can contain in a range of from 1% to 50% by weight in one embodiment, in a range of from 10% to 40% by weight in another embodiment, in a range of from 20% to 40% by weight in yet another embodiment, based on the weight of the binder, of acrylic NAD (non-aqueous dispersed) resins. These NAD resins typically can include high molecular weight resins having a crosslinked acrylic core with a Tg between 20 to 100° C. and attached to the core are low Tg stabilizer segments. Examples of such NAD resins can include those disclosed in U.S. Pat. No. 4,591,533, U.S. Pat. No. 5,010,140 and U.S. Pat. No. 5,763,528.

Typically, a catalyst can be used in the coating composition of this invention to reduce curing time and to allow curing of the coating composition at ambient temperatures. The ambient temperatures are typically referred to as temperatures in a range of from range of 18° C. to 35° C. Typical catalysts include organic metal salts, such as, dibutyl tin dilaurate, dibutyl tin diacetate, dibutyl tin dichloride, dibutyl tin dibromide, zinc naphthenate; compounds containing tertiary amino groups, such as, triethylamine; triphenyl boron, tetraisopropyl titanate, triethanolamine titanate chelate, dibutyl tin dioxide, dibutyl tin dioctoate, tin octoate, aluminum titanate, aluminum chelates, zirconium chelate, hydrocarbon phosphonium halides, such as, ethyl triphenyl phosphonium iodide and other such phosphonium salts, and other catalysts or mixtures thereof known to those skilled in the art.

The coating composition of this invention can comprise one or more solvents. Typically the coating composition can comprise up to 80% by weight, based on the weight of the coating composition, of one or more solvents. Typically, the coating composition of this invention can have a solid content in a range of from 20% to 80% by weight in one example, in a range of from 50% to 80% by weight in another example and in a range of from 60% to 80% by weight in yet another example, all based on the total weight of the coating composition. The coating composition of this invention can also be formulated at 100% solids by using a low molecular weight acrylic resin reactive diluent known to those skilled in the art.

Any typical organic solvents can be used to form the coating composition of this invention. Examples of solvents can include, but not limited to, aromatic hydrocarbons, such as, toluene, xylene; ketones, such as, acetone, methyl ethyl ketone, methyl isobutyl ketone, methyl amyl ketone and diisobutyl ketone; esters, such as, ethyl acetate, n-butyl acetate, isobutyl acetate and a combination thereof.

Typically, when the coating composition of this invention is utilized as a pigmented coating composition, it contains pigments in a pigment to binder weight ratio of 1/100 to 350/100. The coating composition can be used as a basecoat or topcoat, such as a colored topcoat. Conventional inorganic and organic colored pigments, metallic flakes and powders, such as, aluminum flake and aluminum powders; special effects pigments, such as, coated mica flakes, coated aluminum flakes colored pigments, or a combination thereof can be used. Transparent pigments or pigments having the same refractive index as the cured binder can also be used. Such transparent pigments can be used in a pigment to binder weight ratio of 0.1/100 to 5/100. One example of such transparent pigment is silica.

The coating composition of this invention can also comprise one or more ultraviolet light stabilizers in the amount of 0.1% to 10% by weight, based on the weight of the binder. Examples of such ultraviolet light stabilizers can include ultraviolet light absorbers, screeners, quenchers, and hindered amine light stabilizers. An antioxidant can also be added to the coating composition, in the amount of about 0.1% to 5% by weight, based on the weight of the binder.

Typical ultraviolet light stabilizers that are suitable for this invention can include benzophenones, triazoles, triazines, benzoates, hindered amines and mixtures thereof. A blend of hindered amine light stabilizers, such as Tinuvin® 328 and Tinuvin®123, all commercially available from Ciba Specialty Chemicals, Tarrytown, N.Y., under respective registered trademark, can be used.

Typical ultraviolet light absorbers that are suitable for this invention can include hydroxyphenyl benzotriazoles, such as, 2-(2-hydroxy-5-methylphenyl)-2H-benzotrazole, 2-(2-hydroxy-3,5-di-tert.amyl-phenyl)-2H-benzotriazole, 2[2-hydroxy-3,5-di(1,1-dimethylbenzyl)phenyl]-2H-benzotriazole, reaction product of 2-(2-hydroxy-3-tert.butyl-5-methyl propionate)-2H-benzotriazole and polyethylene ether glycol having a weight average molecular weight of 300, 2-(2-hydroxy-3-tert.butyl-5-iso-octyl propionate)-2H-benzotriazole; hydroxyphenyl s-triazines, such as, 2-[4((2,-hydroxy-3-dodecyloxy/tridecyloxypropyl)-oxy)-2-hydroxyphenyl]-4,6-bis(2,4-dimethylphenyl)-1,3,5-triazine, 2-[4(2-hydroxy-3-(2-ethylhexyl)-oxy)-2-hydroxyphenyl]-4,6-bis(2,4-dimethylphenyl)1,3,5-triazine, 2-(4-octyloxy-2-hydroxyphenyl)-4,6-bis(2,4-dimethylphenyl)-1,3,5-triazine; hydroxybenzophenone U.V. absorbers, such as, 2,4-dihydroxybenzophenone, 2-hydroxy-4-octyloxybenzophenone, and 2-hydroxy-4-dodecyloxybenzophenone.

Typical hindered amine light stabilizers can include N-(1,2,2,6,6-pentamethyl-4-piperidinyl)-2-dodecyl succinimide, N(1 acetyl-2,2,6,6-tetramethyl-4-piperidinyl)-2-dodecyl succinimide, N-(2hydroxyethyl)-2,6,6,6-tetramethylpiperidine-4-ol-succinic acid copolymer, 1,3,5 triazine-2,4,6-triamine, N,N′″-[1,2-ethanediybis[[[4,6-bis[butyl(1,2,2,6,6-pentamethyl-4-piperidinyl)amino]-1,3,5-triazine-2-yl]imino]-3,1-propanediyl]]bis[N,N′″-dibutyl-N′, N′″-bis(1,2,2,6,6-pentamethyl-4-piperidinyl)], poly-[[6-[1,1,3,3-tetramethylbutyl)-amino]-1,3,5-trianzine-2,4-diyl][2,2,6,6-tetramethylpiperidinyl)-imino]-1,6-hexane-diyl[(2,2,6,6-tetramethyl-4-piperidinyl)-imino]), bis(2,2,6,6-tetramethyl-4-piperidinyl)sebacate, bis(1,2,2,6,6-pentamethyl-4-piperidinyl)sebacate, bis(1-octyloxy-2,2,6,6-tetramethyl-4-piperidinyl)sebacate, bis(1,2,2,6,6-pentamethyl-4-piperidinyl)[3,5bis(1,1-dimethylethyl-4-hydroxy-phenyl)methyl]butyl propanedioate, 8-acetyl-3-dodecyl-7,7,9,9,-tetramethyl-1,3,8-triazaspiro(4,5)decane-2,4-dione, and dodecyl/tetradecyl-3-(2,2,4,4-tetramethyl-2l-oxo-7-oxa-3,20-diazal dispiro(5.1.11.2)henicosan-20-yl)propionate.

Typical antioxidants that are suitable for this invention can include tetrakis[methylene(3,5-di-tert-butylhydroxy hydrocinnamate)]methane, octadecyl 3,5-di-tert-butyl-4-hydroxyhydrocinnamate, tris(2,4-di-tert-butylphenyl)phosphite, 1,3,5-tris(3,5-di-tert-butyl-4-hydroxybenzyl)-1,3,5-triazine-2,4,6(1H,3H,5H)-trione and benzenepropanoic acid, 3,5-bis(1,1-dimethyl-ethyl)-4-hydroxy-C7-C9 branched alkyl esters. Typically useful antioxidants can also include hydroperoxide decomposers, such as Sanko® HCA (9,10-dihydro-9-oxa-10-phosphenanthrene-10-oxide), triphenyl phosphate and other organo-phosphorous compounds, such as, Irgafos® TNPP from Ciba Specialty Chemicals, Irgafos® 168, from Ciba Specialty Chemicals, Ultranox® 626 from GE Specialty Chemicals, Mark PEP-6 from Asahi Denka, Mark HP-10 from Asahi Denka, Irgafos® P-EPQ from Ciba Specialty Chemicals, Ethanox 398 from Albemarle, Weston 618 from GE Specialty Chemicals, Irgafos® 12 from Ciba Specialty Chemicals, Irgafos® 38 from Ciba Specialty Chemicals, Ultranox® 641 from GE Specialty Chemicals and Doverphos® S-9228 from Dover Chemicals.

The coating compositions of this invention can comprise conventional coating additives. Examples of such additives can include wetting agents, leveling and flow control agents, for example, Resiflow®S (polybutylacrylate), BYK® 320 and 325 (high molecular weight polyacrylates), BYK® 347 (polyether-modified siloxane) under respective registered trademarks, leveling agents based on (meth)acrylic homopolymers; rheological control agents, such as highly disperse silica, fumed silica or polymeric urea compounds; thickeners, such as partially crosslinked polycarboxylic acid or polyurethanes; and antifoaming agents. The additives are used in conventional amounts familiar to those skilled in the art.

The coating compositions according to this invention can further contain reactive low molecular weight compounds as reactive diluents that are capable of reacting with the crosslinking agent. For example, low molecular weight polyhydroxyl compounds, such as, ethylene glycol, propylene glycol, trimethylolpropane and 1,6-dihydroxyhexane can be used.

Depending upon the type of crosslinking agent, the coating composition of this invention can be formulated as one-pack (1K) or two-pack (2K) coating composition. If polyisocyanates with free isocyanate groups are used as the crosslinking agent, the coating composition can be formulated as a two-pack coating composition in that the crosslinking agent is mixed with other components of the coating composition only shortly before coating application. If blocked polyisocyanates are, for example, used as the crosslinking agent, the coating compositions can be formulated as a one-pack (1K) coating composition. The coating composition can be further adjusted to spray viscosity with organic solvents as determined by those skilled in the art before being applied.

In a typical two-pack coating composition comprising two packages, the two packages are mixed together shortly before application. The first package typically can contain the binder including the polyester having one or more hydroxyl crosslinkable functional groups, the polytrimethylene ether diol and optionally, pigments. The pigments can be dispersed in the first package using conventional dispersing techniques, for example, ball milling, sand milling, and attritor grinding. The second package can contain the crosslinking agent, such as, a polyisocyanate crosslinking agent, and solvents.

The coating composition according to the disclosure can be suitable for vehicle and industrial coating and can be applied using known processes. In the context of vehicle coating, the coating composition can be used both for vehicle original equipment manufacturing (OEM) coating and for repairing or refinishing coatings of vehicles and vehicle parts. Curing of the coating composition can be accomplished at ambient temperatures, such as temperatures in a range of from 18° C. to 35° C., or at elevated temperatures, such as at temperatures in a range of from 35° C. to 150° C. Typical curing temperatures of 20° C. to 80° C., in particular of 20° C. to 60° C., can be used for vehicle repair or refinish coatings.

The coating composition can be applied by conventional techniques, such as, spraying, electrostatic spraying, dipping, brushing, and flow coating. Typically, the coating is applied to a dry film thickness of 20 to 300 microns and preferably, 50 to 200 microns, and more preferably, 50 to 130 microns.

The use of polytrimethylene ether diol in coating compositions has been described in U.S. Pat. No. 6,875,514, U.S. Pat. No. 7,169,475 and U.S. Pat. No. 7,268,182. However, all patents require polymers having a Tg at or higher than 10° C. Such coatings with high Tg polymers provide high early hardness, such as 3 hour or one day hardness that is especially useful for early sanding of the coatings in refinishing or repairing automotive vehicles or trucks. For other coating applications such as coating steel tanks, pipelines, or other industrial structures, early sanding may not be required while adhesion to different substrates and flexibility can be challenging. The coatings with those high Tg polymers do not provide sufficient flexibility. The applicants unexpectedly discovered that by combining polyesters of low Tg, i.e., Tg below 10° C., in a range of from −75° C. to +5° C., polytrimethylene ether diol and a crosslinking agent, coating layers produced from the coating composition of this invention can have good flexibility and improved adhesion to different substrates, especially to substrates having one or more existing coating layers.

A coating that is produced from the coating composition of this invention can having balanced coating properties, such as lower viscosity as a sprayable pot mix, good adhesion to substrates, high flexibility and good early hardness.

The linear or the branched polyesters, or a combination thereof can be suitable for this invention. In one example, only linear polyesters are used in the coating composition. In another example, only the branched polyesters are used in the coating composition. In yet another example, both the linear and the branched polyesters are used in the coating composition. Typically, the coatings comprising the branched polyesters can have lower viscosity, shorter dry-to-touch time and better early hardness comparing to the coatings comprising the linear polyesters. The shorter dry-to-touch time and higher early hardness are typically useful for increasing productivity in coating applications since the substrates being coated can be moved to next coating process in a shorter time.

The coating composition of this invention forms finishes with good adhesion to various substrates such as blasted steel and other coating layer or layers such as primer layers formed by common industrial primers.

The present disclosure is further defined in the following Examples. It should be understood that these Examples are given by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative examples set forth herein below, but rather is defined by the claims contained herein below.

### Testing Procedures

Dry Film Thickness—test method ASTM D4138

Viscosity—Viscosity was measured as Gardner-Holdt viscosity according to ASTM ″D 1545, Zahn Viscosity (cup) using a #1 Zahn cup according to ASTM D 1084 Method D, or in Krebs Unit (KU) viscosity according to ASTM D562-01, respectively, as specified in this invention.

Persoz Hardness Test—the change in film hardness of the coating was measured with respect to time, in second, after application by using a Persoz Hardness Tester Model No. 5854 [ASTM D4366] supplied by Byk-Mallinckrodt, Wallingford, Conn.

Fischer Hardness—was measured using a Fischerscope® Hardness Tester. The measurement is in Newtons per square millimeter.

Tg (glass transition temperature) of a polymer is determined according to ASTM D-3418 (1988) or calculated according to the Fox Equation.

Molecular weight and hydroxyl number of the polytrimethylene ether diol are determined according to ASTM E222.

Molecular weights Mw and Mn and the polydispersity (Mw/Mn) of the acrylic polymer and other polymers are determined by GPC (Gel Permeation Chromatography) using polystyrene standards and tetrahydrofuran as the solvent.

Cross-Hatch Adhesion Test—The cross hatch tape test is primarily intended for use in the laboratory. A cross-hatch pattern is created using a special cross-hatch cutter with multiple preset blades can be used to make parallel incisions with proper space. After the tape has been applied and pulled off, the cut area is inspected and rated. The foregoing test is based on a standard method for the application and performance of these adhesion tests available in ASTM D3359 B. Adhesion can be rated on a sliding scale, which ranges from 0B (no adhesion, i.e., total failure) to 5B (complete adhesion, i.e., total success). A rating of 3B and higher is preferable and a rating of 4B and higher is more preferable. A device described in U.S. Patent Publication No. 2006/0042724, published on Mar. 2, 2006, filed on Jun. 16, 2005 with an application Ser. No. 11/154,487, can be used to create properly spaced and parallel incisions into the coating.

Dry to touch time—Dry to touch time is determined by ASTM D1640.

In the following examples, all parts and percentages are on a weight basis unless otherwise indicated. “Mw” weight average molecular weight and “Mn” means number average molecular weight. “PBW” means parts by weight.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Procedure 1

### Preparation of Polyesters

### (A) Preparation of Linear Polyesters:

A polyester was prepared by charging the following ingredients according to Table 1 into a reaction vessel equipped with a heating mantle, water separator, thermometer and stirrer, and under nitrogen.

TABLE 1
Reaction Ingredients (grams).

| | Weight |
|---|---|
| Portion 1 | |
| Xylene | 19.553 |
| Pentaerythritol | 93.58 |
| Benzoic acid | 167.89 |
| Portion 2. | |
| Neopentyl glycol | 296.21 |
| Isophthalic acid | 142.80 |
| Phthallic anhydride | 127.29 |
| Adipic acid | 62.78 |
| Xylene | 15.26 |
| Portion 3 | |
| Ethyl acetate | 113.51 |

Portion 1 was added to the reactor and heated to its reflux temperature, about 190° C. The reactor was heated stepwise to 215° C. and held until the acid number was 33 or less. After cooling the reactor to 80° C., Portion 2 was added and the reactor was heated to reflux, about 175° C. The temperature was then increased stepwise to 215° C. That temperature was held until an acid number between 3 and 7 at about 98 wt % solids was reached. Portion 3 was added after cooling to about 80° C. The resulting polymer had a wt % solids of about 82%, and Gardner-Holdt viscosity between Z1+½ to Z3+¼.

### (B) Preparation of Branched Polyesters:

Branched polyester was prepared by charging the following ingredients in Table 2 into a reaction vessel equipped with a heating mantle, short path distillation head with a water separator, thermometer and stirrer, and under nitrogen.

TABLE 2
Reaction Ingredients (Parts by Weight).

| | Parts by weight |
|---|---|
| Portion 1 | |
| Caprolactone | 376.04 |
| Stannous octoate | 2.83 |
| Xylene | 43.52 |
| Portion 2 | |
| Dimethylol propionic acid | 188.02 |
| Pentaerythritol | 7.62 |
| Portion 3 | |
| Methyl amyl ketone | 252.22 |

Portion 1 was added to the reactor in order with mixing and heated to about 70° C. Portion 2 was then added to the reactor and the reaction mixture was heated to its reflux temperature (170-200° C.) and the water of reaction was collected in the water separator. The reaction mixture was not allowed to exceed 200° C. and was held at temperature until an acid number less than 3 at 92.7 wt % solids was obtained. The polymer solution was thinned with Portion 3 to desired solids and viscosity. The resulting polymer had a wt % solids between 64.5 and 67.5 wt % solids and a Gardner-Holdt viscosity between N and R.

### Procedure 2

### Preparation of Pigments Dispersion

A red dispersion was prepared using the following procedure.

TABLE 3
Pigments Dispersion

| Ingredient | Wt (grams) |
|---|---|
| t-butyl acetate | 72.7 |
| EFKA ®-4340 dispersant⁽¹⁾ | 35.4 |
| Magnesium montmorillonite⁽²⁾ | 2.3 |
| Linear polyester⁽³⁾ | 211.6 |
| Total | 321.8 |

⁽¹⁾Available from Ciba ® Specialty Chemicals Inc, Tarrytown, New York, USA, under respective registered trademarks.
⁽²⁾Available as Bentone ® 27 from Elementis Specialties Inc., Hightstown, New Jersey, USA, under respective registered trademarks.
⁽³⁾The linear polyester was formed from following monomers at the specified molar ratio: benzoic acid 6.4/pentaerythritol 3.2/noepentyl glycol 12.8/isophthalic acid 4.0/phthalic acid 4.0/adipic acid 2.0. The linear polyester has a weight molecular weight of Mw 1,700, and a Tg of +3° C.

Ingredients in Table 3 were added in order to an attritor with mixing and mixed for approximately 5 minutes. The Quinacridone red pigment (Cinquasia red YRT-859-D by Ciba Specialty Chemicals) was slowly added and the mixture was mixed for another 5 minutes. The grinding media containing 1816 grams of ⅛″ steel shots were added. The mixture was milled for 5 hours at 350 rpm. The dispersion was separated from the grinding media. The pigment was well dispersed to give a uniform dispersion with a viscosity of 770 cps at 20 rpm as measured by a Brookfield viscometer.

### Coating Compositions

Comparative coating compositions were prepared according to Table 4. Examples of coating compositions of this invention were prepared according to Table 5 to form individual pot mix.

TABLE 4
Comparative Coating Compositions (grams).

| | Comp 1 | Comp 2 | Comp 3 | Comp 4 | Comp 5 |
|---|---|---|---|---|---|
| Low Tg Linear | 50.0 | — | 88.0 | — | — |
| polyester⁽¹⁾ | | | | | |
| Branched | — | 50.0 | — | 88.0 | — |
| polyester^{(1a)} | | | | | |
| High Tg Linear | — | — | — | — | 50.0 |
| polyester^{(1b)} | | | | | |
| Pigments | 32.0 | 32.0 | 32.0 | 32.0 | 32.0 |
| Dispersion⁽²⁾ | | | | | |
| Polytrimethylene | — | — | — | — | 38.0 |
| ether diols⁽³⁾ | | | | | |
| PPG2000⁽⁴⁾ | 38.0 | 38.0 | — | — | — |
| Isocyanates | 45.0 | 45.0 | 54.0 | 54.0 | 30.0 |
| crosslinking | | | | | |
| agent (FG-1333)⁽⁵⁾ | | | | | |
| Total | 165.0 | 165.0 | 174.0 | 174.0 | 150.0 |
| Solid percentage | 60.0 | 61.0 | 59.5 | 62.5 | 61.5 |
| NCO/OH Ratio | 1.00 | 1.01 | 1.00 | 1.01 | 1.00 |
| Pot life (hours) | 3.0 | 1.5 | 1.0 | 0.5 | 2.5 |

⁽¹⁾The linear polyester was from “Procedure 1(A)”. The linear polyester has a weight molecular weight of Mw 1,700, and a Tg of +3° C.
^{(1a)}The branched polyester was from “Procedure 1(B)” with specified weight percentage (wt %): caprolactone 65.78 wt %/dimethylol propionic acid 32.89 wt %/pentaerythritol 1.33 wt %. The branched polyester has a weight molecular weight of Mw 20,000, and a Tg of −50° C.
^{(1b)}This high Tg linear polyester was formed according to general procedure described in “Procedure 1(A)”, however, using following monomers at the specified molar ratio: trimethylol propane 13.6/noepentyl glycol 34.1/isophthalic acid 27.7/phthalic anhydride 12.9/adipic acid 11.7. The linear polyester has a weight molecular weight of Mw 7,500, and a Tg of +20° C.
⁽²⁾Pigments dispersion was from Procedure 2.
⁽³⁾Polytrimethylene ether diols were prepared according to the process described in U.S. Pat. No. 6,875,514, col. 9, line 29 through col. 10, line 8. Number average molecular weight (Mn) was about 1,300-1,450 with hydroxyl number of 77.4-86.3.
⁽⁴⁾PPG2000: polypropylene glycol having a molecular weight of 2000 from Aldrich Chemical Company, Product No. 81380.
⁽⁵⁾FG-1333 is a crosslinking activator comprising diisocyanates, available from E. I. DuPont de Nemours and Company, Wilmington, DE, USA.

TABLE 5
Coating Compositions (grams).

| | Example 1 (with | Example 2 (with |
|---|---|---|
| | Linear Polyester) | Branched Polyester) |
| Linear polyester ⁽¹⁾ | 50.0 | — |
| Branched polyester ^{(1a)} | — | 50.0 |
| Pigments Dispersion ⁽²⁾ | 32.0 | 32.0 |
| Polytrimethylene ether | 38.0 | 38.0 |
| diols ⁽³⁾ | | |
| PPG2000 ⁽⁴⁾ | — | — |
| Isocyanates crosslinking | 48.0 | 48.0 |
| agent (FG-1333) ⁽⁵⁾ | | |
| Total | 168.0 | 168.0 |
| Solid percentage | 60.5% | 61.0% |
| NCO/OH Ratio | 1.00 | 1.01 |
| Pot life (hours) | 2.0 | 1.0 |

Notes ⁽¹⁾, ^{(1a)}, and ⁽²⁾-⁽⁵⁾:
same as those in Table 4.

### Coating Properties

The coating compositions were applied by drawdown on substrates. Each substrate was a steel plate that had been coated with high solid epoxy primer Corlar® 2.8-PR™) available from E. I. DuPont de Nemours and Company, Wilmington, Del., USA, under respective registered and unregistered trademarks. The coating compositions were wet drawdown onto the substrate over the dried primer layer forming a dry film at about 2 mil (about 50 micron) in thickness.

Dry time of the coating layers was measured according to ASTM D1640. Adhesion was measured using the aforementioned Cross-Hatch adhesion test. A score of 0B indicates total failure on adhesion. A score of 5B indicates perfect adhesion.

Data on coating properties are shown in Table 6. The data indicated that the Examples of the coating composition of this invention had good adhesion to the epoxy primer layer, good viscosity, and good flexibility.

The comparatives 1 and 2 failed to adhere to the epoxy primer layer. The comparatives 1 and 2 also had long dry to touch time making it of very low value for practical use.

The comparatives 3 and 4 showed slightly better adhesion (not adequate for practical purposes, however) to the epoxy primer than the comparatives 1 and 2 but had much higher viscosity at the same volume solids making spray application difficult. The comparatives 3 and 4 also had shorter pot-life. The comparative 4 showed higher productivity than the comparative 3 as shown in the hardness development because of better accessibility of hydroxyl groups in the branched structure of polyester.

Comparative 5 comprised high Tg linear polyester (Tg=20° C.). The coating had good adhesion to both epoxy primer layer and the blasted steel, however, was less flexible.

TABLE 6
Coating Properties.

| | Dry to | | Adhesion | Adhesion | | 1 day | 7 day |
|---|---|---|---|---|---|---|---|
| | touch | | to Epoxy | to | | Persoz | Persoz |
| | time | Viscosity | Primer | blasted | | hardness | hardness |
| | (hours) | [KU]⁽¹⁾ | Layer | steel | Flexibility⁽²⁾ | (second)⁽³⁾ | (second)⁽³⁾ |
| Comparative | >24 | 62 | 0B | 0B | 28% | 5 | 10 |
| 1 | | | | | | | |
| Comparative | >24 | 57 | 0B | 0B | 28% | 5 | 10 |
| 2 | | | | | | | |
| Comparative | 4 | 75 | 3B | 4B | 28% | 10 | 34 |
| 3 | | | | | | | |
| Comparative | 1 | 70 | 3B | 4B | 28% | 22 | 25 |
| 4 | | | | | | | |
| Comparative | 2 | 60 | 5B | 5B | 15% | 62 | 71 |
| 5 | | | | | | | |
| Example 1 | 5 | 58 | 5B | 5B | 28% | 13 | 30 |
| Example 2 | 3 | 55 | 5B | 5B | 28% | 20 | 23 |

⁽¹⁾viscosity [Krebs Unit] was measured at 65% volume solids according to ASTM D562-01.
⁽²⁾The flexibility test was done with 1 mil coating film using the Mandrel Bending test method. The values represent percent elongation.
⁽³⁾Hardness measurement was performed as described in “Testing Procedures”.

What is claimed is:

1. A coating composition comprising a film forming binder, said binder consists essentially of:
A) a polyester having one or more hydroxyl crosslinkable functional groups and having a glass transition temperature (Tg) in a range of from −75° C. to 5° C.;
B) a polytrimethylene ether diol having a Mn (number average molecular weight) a range of from 500 to 10,000; and
C) a crosslinking component consisting essentially of at least one crosslinking agent having one or more crosslinking functional groups.

2. The coating composition of claim 1, wherein the polytrimethylene ether diol has a Mn in a range of from 500 to 4,000, a Tg of about −75° C. and a hydroxyl number in a range of from 20 to 200.

3. The coating composition of claim 1, wherein the polytrimethylene ether diol is a blend of high and low molecular weight polytrimethylene ether diols wherein the high molecular weight polytrimethylene ether diol has an Mn in a range of from 1,000 to 4,000 and the low molecular weight polytrimethylene ether diol has an Mn in a range of from 150 to 500 and the average Mn of the blend is in a range of from 1,000 to 4,000.

4. The coating composition of claim 1, wherein the polytrimethylene ether diol is polymerized from bio-derived 1,3-propanediol.

5. The coating composition of claim 1, wherein at least one of said one or more crosslinking functional groups is isocyanate group.

6. The coating composition of claim 1, wherein the polyester is one or more linear polyesters, one or more branched polyesters, or a combination thereof.

7. The coating composition of claim 6, wherein said linear polyesters have a weight average molecular weight of 500 to 5,000 and are polymerized from monomers selected from the group consisting of benzoic acid, pentaerythritol, noepentyl glycol, isophthalic acid, phthalic acid, adipic acid, and a combination thereof.

8. The coating composition of claim 6, wherein said branched polyesters have a weight average molecular weight of 1,000 to 50,000 and are polymerized from monomers selected from the group consisting of caprolactone, dimethylol propionic acid, pentaerythritol, add more monomer from spec and a combination thereof.

9. The coating composition of claim 1, wherein the crosslinking agent is one or more organic polyisocyanates selected from the group consisting of aliphatic polyisocyanates, cycloaliphatic polyisocyanates, aromatic polyisocyanates, trifunctional isocyanates and isocyanate adducts.

10. The coating composition of claim 1, 2, 3, 4, 5, 6, 7, 8, or 9 further comprising one or more solvents, one or more pigments, ultraviolet light stabilizers, ultraviolet light absorbers, antioxidants, hindered amine light stabilizers, leveling agents, rheological agents, thickeners, antifoaming agents, wetting agents, catalysts, or a combination thereof.

11. A substrate coated with the coating composition of claim 1, 2, 3, 4, 5, 6, 7, 8, or 9.

12. A process for coating a substrate having at least one existing coating layer thereon, said process comprising the steps of:
(A) applying a coating composition over said existing coating layer to form an overlay coating layer, wherein said coating composition comprises a film forming binder consisting essentially of:
(i) a polyester having one or more hydroxyl crosslinkable functional groups and having a glass transition temperature (Tg) in a range of from −75° C. to 5° C.;
(ii) a polytrimethylene ether diol having a Mn (number average molecular weight) a range of from 500 to 10,000; and
(iii) a crosslinking component consisting essentially of at least one crosslinking agent having one or more crosslinking functional groups.
(B) curing said overlay coating layer to form an overlay coating on said substrate.

13. The process of claim 12, wherein the polytrimethylene ether diol is polymerized from bio-derived 1,3-propanediol.

14. The process of claim 12, wherein at least one of said one or more crosslinkable functional groups is hydroxyl groups, and wherein at least one of said one or more crosslinking functional groups is isocyanate group.

15. The process of claim 12, wherein said existing coating layer is an epoxy primer layer.

16. A substrate coated with the process of claim 12, 13, 14, or 15.
